(19) United States
(12) Patent Application Publication
(10) Pub. No.: US 2026/0300024 A1
(43) Pub. Date: Oct. 1, 2026

(54) SYSTEMS AND METHOD FOR MANAGING MACHINES

(71) Applicant: Caterpillar Inc., Peoria, IL (US)

(72) Inventors: Russell Allen Brockhurst, Carindale (AU); Ramakrishna Mathiraj, Chennai (IN); Basava Naga Girish Koneru, Chennai (IN); Visalatchi Nagappan, Coimbatore (IN)

(73) Assignee: Caterpillar Inc., Peoria, IL (US)

(21) Appl. No.: 19/093,313

(22) Filed: Mar. 28, 2025

(51) Int. Cl. G06F 9/50

(52) U.S. Cl. CPC G06F 9/505

(57) ABSTRACT

A system for managing a plurality of machines is disclosed. The system is configured to determine a machine cycle time for completion of a task in a production circuit. The production circuit comprises a path to be traversed by one or more machines to complete the task. The system is also configured to determine a count of the machines in the production circuit. Further, the system is configured to coordinate movement of the machines traversing along the path based on the determined machine cycle time and the determined count such that a predefined count of the machines is present at a predefined location along or proximate to the path at a predefined time or during a predefined time period.

### TECHNICAL FIELD

The present disclosure relates, in general, to systems and a method for managing machines.

### BACKGROUND

In a production circuit, machines such as, but not limited to, haul trucks, are employed to perform different tasks, such as, loading and dumping of material(s) from at least one loading location to at least one dumping location within the production circuit. At present, the loading and the dumping of the material(s) performed by the machines occur randomly depending on the availability of the materials, the machines, or operators operating the machines. Due to lack of coordination between the machines while performing the tasks, an arrival of the machines at the dumping location may be concurrent with each other in some instances and may be sparse or limited in other instances. Concurrent arrivals of machines may result in queuing of the machines at the dumping location and sparse or limited arrivals of machines may cause delay in production activities such as, but not limited to, crushing and/or blending materials received from different production circuits. Further, such uncoordinated arrival of the machines may also impact compliance parameters such as, but not limited to, a ratio or percentage of each material of the different materials to be blended together at the same time or at different times depending on production requirements associated with blending of the materials. With the compliance parameters impacted, countermeasures such as, but not limited to, secondary mixing of one or more materials are undertaken, thereby resulting in increase in production costs and time required for the blending.

Similarly, in an electrified production circuit, the lack of coordination between machines including, but not limited to, battery electric machines (BEMs) and diesel electric machines, may result in issues including, but not limited to, queuing of the BEMs at charging infrastructures including, but not limited to, stationary charging stations or dynamic charging trolleys provided in the electrified production circuit, underutilization of the stationary charging stations or the dynamic charging trolleys due to sparse or limited arrivals of the battery electric machines at the stationary charging stations or the dynamic charging trolleys, queuing of the diesel electric machines at different locations within the electrified production circuit, movement of the machines at reduced speed, and/or an increased time for completion of the different tasks assigned to the machines within the electrified production circuit. Consequently, such issues may impact an overall productivity and operational efficiency at the electrified production circuit.

U.S. Pat. No. 12,034,350, herein referred to as the “US '350 reference”, relates to a control system for performing a multi-phase implementation for monitoring machines and/or load data in response to data received at different times, updating the material load and blend characteristics, and controlling machines at the site based on the characteristics of the material load or material blend. The control system of US '350 reference determines and provides operating instructions for the machines such that appropriate materials will be extracted, hauled, processed, and added to the blend to maintain an optimal material blend and/or target blend range. The control system of US '350 also optimizes one or more additional factors such as machine efficiency, driving distance, and material processing rate. The monitoring of the machines and load data at different times and instructing the machines based on the monitoring merely ensures that the optimal material blend is maintained consistently. However, issues associated with queuing of the machines at dumping locations and increase in production time and costs in consistently attempting to maintain the optimal material blend may persist.

### SUMMARY

In an aspect of the present disclosure, a system for managing a plurality of machines is disclosed. The system comprises a processor and a memory for storing instructions that when executed by the processor, causes the processor to determine a machine cycle time for completion of at least one task in at least one production circuit. The at least one production circuit comprises at least one path to be traversed by at least one set of machines of the plurality of machines to complete the at least one task. The processor is also configured to determine a count of the at least one set of machines assigned to perform the at least one task in the at least one production circuit. Further, the processor is configured to coordinate movement of the at least one set of machines traversing along the at least one path such that a predefined count of the at least one set of machines is present at a predefined location along or proximate to the at least one path at a predefined time or during a predefined time period.

In another aspect of the present disclosure, a system for managing a plurality of machines is disclosed. The system comprises a processor and a memory for storing instructions that when executed by the processor, causes the processor to determine a first machine cycle time for completion of a first task in a first production circuit and a second machine cycle time for completion of a second task in a second production circuit. The first production circuit comprises at least one first path traversed by a first set of machines of the plurality of machines to complete the first task, and the second production circuit comprises at least one second path traversed by a second set of machines of the plurality of machines to complete the first task. The processor is also configured to determine a first count of the first set of machines assigned to perform the first task and a second count of the second set of machines assigned to perform the second task. Further, the processor is configured to determine a ratio of a first planned count of the first set of machines to a second planned count of the second set of machines expected to be present at a predefined location during a same time period. The processor is also configured to coordinate a first movement between the first set of machines traversing along the at least one first path and a second movement between the second set of machines traversing along the at least one second path such that the first planned count of the first set of machines and the second planned count of the second set of machines are present at the predefined location within the same time period according to the determined ratio.

In yet another aspect of the present disclosure, a method for managing a plurality of machines is disclosed. The method comprises a step of determining a machine cycle time for completion of at least one task in at least one production circuit. The at least one production circuit comprises at least one path to be traversed by at least one set of machines of the plurality of machines to complete the at least one task. The method also comprises a step of determining a count of the at least one set of machines assigned to perform the at least one task in the at least one production circuit. Further, the method comprises a step of coordinating a movement between the at least one set of machines based on the determined time duration of the distance such that a predefined count of the at least one set of machines is present at a predefined location along or proximate to the at least one path at a predefined time or during a predefined time period.

### BRIEF DESCRIPTION OF DRAWINGS

FIGS. 1-3 are exemplary illustrations of an environment, in accordance with which various embodiments of the present disclosure are implemented;

FIG. 4 is an exemplary block diagram of a system for managing machines, in accordance with embodiments of the present disclosure;

FIG. 5 is an exemplary block diagram of a machine system provided in each machine employed in the environment of FIGS. 1-3, in accordance with the embodiments of the present disclosure;

FIG. 6 is an exemplary illustration of coordination of movement of machines between production circuits in the environment of FIG. 1, in accordance with the embodiments of the present disclosure;

FIG. 7 is an exemplary method for managing machines, in accordance with the embodiments of the present disclosure; and

FIG. 8 is an exemplary illustration of coordination of movement of machines in a production circuit in the environment of FIG. 1, in accordance with the embodiments of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

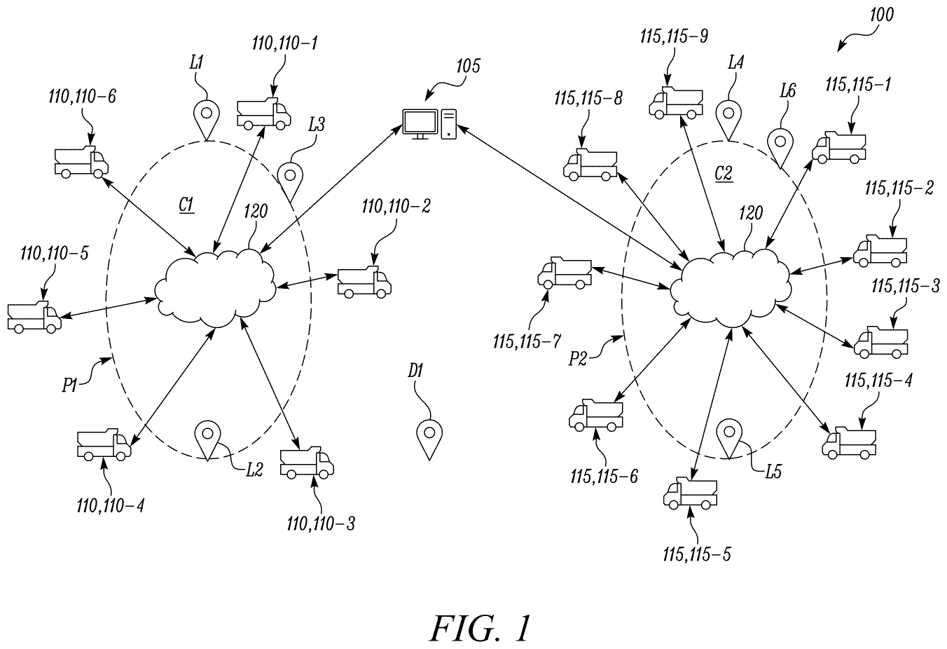

Referring to FIG. 1, an environment 100, herein referred to as, ‘worksite 100’, including machines, for example, 110 and 115 and a system 105 in communication with the machines, for example, 110 and 115, via the network 120 is disclosed. Examples of the system 105 include, but are not limited to, computers, laptops, mobile devices, handheld devices, personal digital assistants (PDAs), tablet personal computers, digital notebook, wearables, and other electronic devices now known or in future developed. It will be understood by those with ordinary skill in the art that the system 105 may also correspond to one or more or a collection of virtual servers, physical servers, remote cloud servers, on-premises cloud servers, and other servers presently known or in future developed. Examples of the machines, for example, 110, 115, include, but are not limited to, haul trucks, water trucks, loaders, excavators, shovels, and tractors. In embodiments, the machines, for example, 110, 115 correspond to Battery Electric Machines (BEMs) configured to operate on electric power derived from a battery power source and/or Diesel Electric Machines (DEMs) configured to operate on electric power derived from a diesel internal combustion engine. In embodiments, the machines, for example, 110, 115 are autonomous machines or manually controlled machines such as those operated by an operator. Examples of the network 120 include, but are not limited to, a Local Area Network (LAN), a Wireless Local Area Network (WLAN), a Small Area Network (SAN), a Wi-Fi Direct Network, satellite network, low power long range network (LoRa), and a telecommunication network including, but not limited to, a fourth generation (4G) and a fifth generation (5G) cellular network. In embodiments, the worksite 100 includes at least one production circuit, for example, a first production circuit C1 and/or a second production circuit C2. Each production circuit, for example, C1 includes at least one path, for example, P1, to be traversed by at least one set of machines, for example, 110-1 through 110-6 of the plurality of machines, for example, 110, 115, to complete at least one task. For example, the first production circuit C1 may include a first path, for example, P1 to be traversed by a first set of machines, for example, 110-1 through 110-6 to complete a first task. Similarly, the second production circuit C2 may include a second path, for example, P2 to be traversed by second set of machines, for example, 115-1 through 115-9 to complete a second task.

In embodiments, each production circuit, for example, the first production circuit C1 includes at least one location, for example, L1, L2, L3, provided along the at least one path, for example, the first path P1 for at least one machine, for example, the first set machine 110-1 to perform the at least one task including, but not limited to, loading or dumping of materials. For example, the location L1 may correspond to a loading location including, but not limited to, a Run-Of-Mine (ROM) pad or a location assigned for an unmapped material, a mining block, a stockpile, or a loadout unit, for the machines, for example, 110-1 to load material or inventory onto the machines, for example, 110-1 and the location L2 may correspond to a dumping location for the machines, for example, 110-3 to deliver the loaded material at the location L1 to the location L2. In embodiments, the ROM pad corresponds to, for example, a storage area for run-off mine ore materials of varying grades. In some embodiments, the location L3 may correspond to, for example, a stationary charging station or a dynamic charging trolley provided for charging the machines, for example, 110-1 through 110-6. Examples of the dynamic charging trolley(s) include, but are not limited to, overhead electrical wires, electrified side rails, and/or electrical conductors embedded on the path, for example, P1 traversed by the machines such as the BEMs. It will be appreciated by those with ordinary skill in the art that other designs for the dynamic charging trolleys are also possible and envisioned, including, but not limited to, designs employing trolley poles, bow collectors, underbody collectors, and other forms of ‘live’ electricity transfer. For example, the dynamic charging trolleys may alternatively include a ground-level power supply having one or more contact lines having conductive rails or tracks; and a charging apparatus at the dynamic charging trolleys may include an underbody collector configured to interact therewith. In other examples, the dynamic charging trolleys may include non-contact conductors, such as those facilitating in-road inductive charging. It will be appreciated by those with ordinary skill in the art that the contact lines may embody any form of ‘live’ electricity supply, and the associated charging apparatus may embody any form of ‘live’ electricity receipt, depending on specific applicational requirements.

Similarly, the production circuit, for example, the second production circuit C2 includes at least one location, for example, L4, L5, L6, provided along the second path, for example, P2 for at least machine, for example, the second set machine 115-1 to perform the at least one task including, but not limited to, loading or dumping of materials. For example, the location L4 may correspond to the loading location for the machines, for example, 115-9 to load material or inventory in the machines, for example, 115-9 and the location L5 may correspond to the dumping location for the machines, for example, 115-5 to deliver the loaded material at location L4 to the location L5. In some embodiments, the location L6 may correspond to the stationary charging station, or the dynamic charging trolley provided for charging one or more of the second set of machines, for example, 115-1 through 115-9 for instances when the one or more of the second set of machines are Battery-Electric-Machines (BEMs). In embodiments, a location, for example, D1 common to different production circuits, for example, the first production circuit C1 and the second production circuit C2, may also be employed within the environment 100. In embodiments, the location D1 corresponds to a common location for the first set of machines, for example, 110-1 through 110-6 in the first production circuit C1 and the second set of machines, for example, 115-1 through 115-9 in the second production circuit C2 to arrive and deliver the material loaded at the location L1 in the first production circuit C1 and the location L4 in the second production circuit C2 respectively to the location D1.

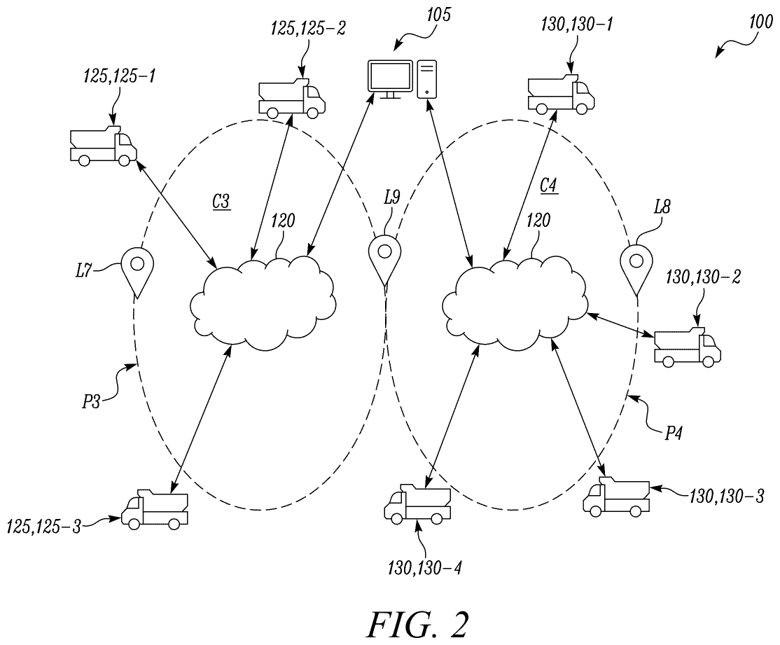

Referring to FIG. 2, the worksite 100 further including the production circuits, for example, a third production circuit C3 and a fourth production circuit C4 is disclosed. The third and the fourth production circuits, for example, C3, C4 include the at least one path, for example, a third path P3 and a fourth path P4 to be traversed by a third set of machines, for example, 125-1 through 125-3 and a fourth set of machines, for example, 130-1 through 130-4 respectively. In embodiments, the third path, for example, P3, includes the locations, for example, L7 and L9 provided along the third path, for example, P3 for the third set of machines, for example, 125-1 through 125-3 to perform at least one task including, but not limited to, the loading or dumping of materials. Similarly, in embodiments, the fourth path, for example, P4, includes the locations, for example, L8 and L9 provided along the fourth path, for example, P4 for the fourth set of machines, for example, 130-1 through 130-4 to perform at least one task including, but not limited to, the loading or dumping of materials. In embodiments, the location L9 may correspond to a dumping location and may be a common location along the paths, for example, P3, P4 associated with the third production circuit C3 and the fourth production circuit C4 respectively for delivering the materials loaded at the locations, for example, L7 and L8 to the location L9 by the third set of machines, for example, 125-1 through 125-3 and the fourth set of machines, for example, 130-1 through 130-4 respectively.

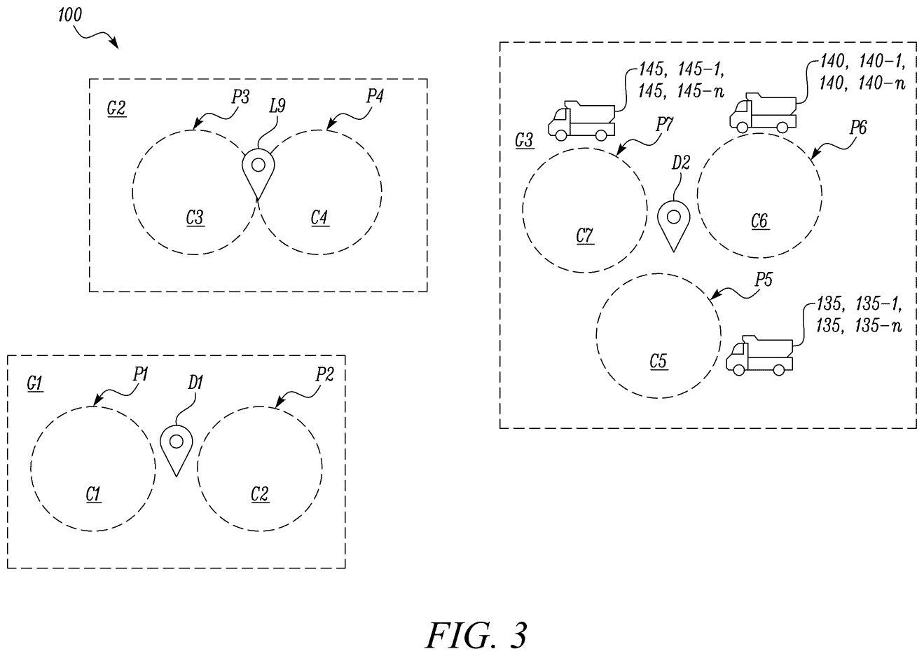

Referring to FIG. 3, the worksite 100 further including the production circuits, C5, C6, and C7 in addition to the production circuits C1, C2, C3, C4 of FIGS. 1-2 is disclosed. In embodiments, the system 105 is configured to determine at least one cluster or group, for example, G1, G2, G3 of the production circuits in the worksite 100 based on at least one location common to or proximate to each production circuit. For example, the system 105 is configured to identify that the location D1 is proximate to both the production circuits C1, C2 and determine a first cluster or group G1 of the production circuits including, for example, the first production circuit C1 and the second production circuit C2 having the location D1 (also see FIG. 1) proximate to both the production circuits C1, C2. Similarly, the system 105 is configured to identify that the location L9 (also see FIG. 2) common to both the production circuits C3, C4 and determine a second cluster or group G2 of the production circuits including, for example, the third production circuit C3 and the fourth production circuit C4 having the location L9 common to both the production circuits C3, C4. As another example, the system 105 is also configured to identify that a location D2 proximate to the production circuits C5, C6, C7 and determine a third cluster or group G3 of the production circuits C5, C6, C7 having the location D2 proximate to the production circuits C5, C6, C7.

Referring to FIGS. 1-3, in embodiments, the system 105 is configured to manage and coordinate movement of the at least one set of machines, for example, 110-1 through 110-6, 115-1 through 115-9 traversing along the at least one path, for example, P1, P2, in the at least one production circuit, for example, C1, C2 such that a predefined count of the at least one set of machines, for example, 110-1 through 110-6, 115-1 through 115-9 is present at a predefined and/or same location, for example, L2, L5, or D1 along or proximate to the at least one path, for example, P1, P2 at a predefined time or during a predefined or same time period. In embodiments, the same time period corresponds to proximate times arrival of the planned count of machines with respect to each other targeted to be present or present at the predefined or same location. For example, the system 105 is configured to manage and coordinate the movement of the at least one set of machines, for example, 110-1 through 110-6 such that at least one machine, for example, 110-3 is present at the location L2 at the predefined time or during the predefined time period. In another example, the system 105 is configured to manage and coordinate the movement of the at least one set of machines, for example, 115-1 through 115-9 such that at least two machines, for example, 115-4 and 115-5 are present together at the location L5 at the predefined time or during the predefined time period.

In embodiments, the system 105 is also configured to manage and coordinate movement of the at least one set of machines, for example, 110-1 through 110-6, 115-1 through 115-9, between the productions circuits, for example, C1, C2 within each determined cluster, for example, G1 of the production circuits, for example, C1, C2 such that the predefined count of the at least one set of machines, for example, 110-1 through 110-6 and/or 115-1 through 115-9 is present at the predefined or same location, for example, D1, along or proximate to the at least one path, for example, P1 and/or P2 at the predefined time or during the predefined or same time period. For example, as shown in FIG. 1, the system 105 may be configured to coordinate the movement of the first set of machines, for example, 110-1 through 110-6 and the second set of machines, for example, 115-1 through 115-9, in the determined cluster G1 of the productions circuits, for example, C1, C2 such that the predefined count, for example, one first set machine, for example, 110-3 of the first set of machines and two second set machines, for example, 115-4, 115-5, of the second set of machines, are present at the predefined or same location, for example, D1, proximate to the paths, for example, P1, P2 at the predefined time or during the predefined or same time period. As another example, as shown in FIG. 2, the system 105 may be configured to coordinate movements of the machines, for example, 125-1 through 125-3 and 130-1 through 130-4 in the determined cluster G2 of the productions circuits, for example, C3, C4 such that the predefined count, for example, two third set machines, for example, 125-1, 125-2 of the third set of machines and 1 fourth set machine, for example, 130-4, of the fourth set of machines are present at the predefined or same location, for example, L9, along the paths, for example, P3, P4 at the predefined time or during the predefined or same time period. In yet another example, as shown in FIG. 3, the system 105 may be configured to coordinate movements of a fifth set of machines, for example, 135-1 through 135-n, a sixth set of machines, for example, 140-1 through 140-n and a seventh set of machines, for example, 145-1 through 145-n in the determined cluster G3 of the productions circuits, for example, C5, C6, C7 such that the predefined count, for example, one fifth set machine, for example, 135-1, one sixth set machine, for example, 140-1, and one seventh set machine, for example, 145-1, of the machines, for example, 135-1 through 135-n, 140-1 through 140-n, and/or 145-1 through 145-n are present at the predefined or same location, for example, D2, proximate to the paths, for example, P5, P6, P7 at the predefined time or during the predefined or same time period.

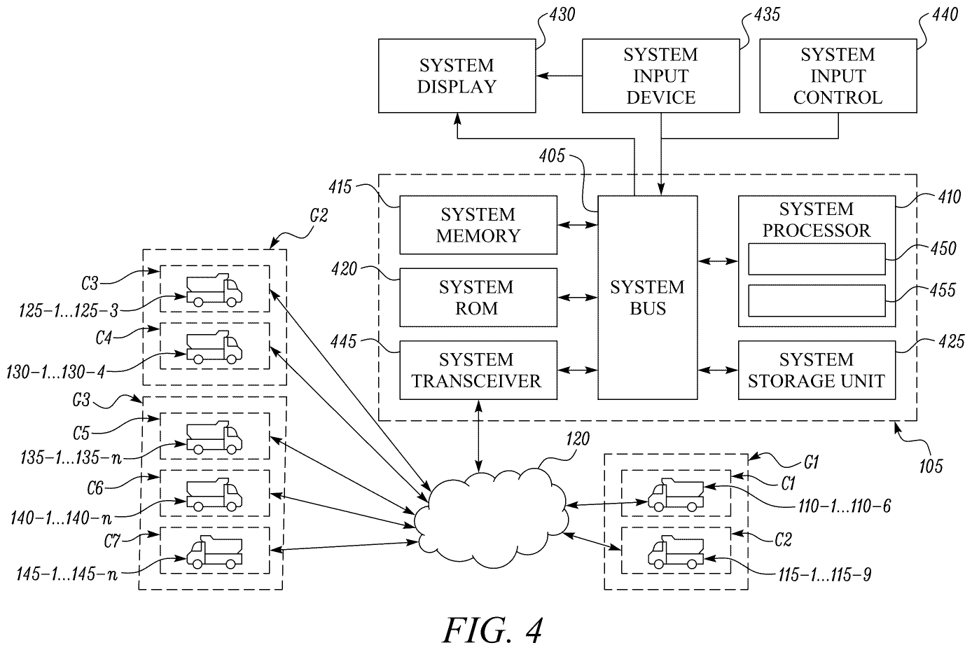

Referring to FIG. 4, a schematic block diagram of the system 105 of FIG. 1 for managing the machines, for example, 110, 115, 125, 130, 135, 140, 145 (see FIGS. 1-3) in the worksite 100 of FIGS. 1-3 is disclosed. The system 105 includes a system bus 405 or other communication mechanism for communicating information, and a system processor 410 coupled with the system bus 405 for processing information. The system 105 also includes a system memory 415, such as a random-access memory (RAM) or other dynamic storage device, coupled to the system bus 405 for storing information and instructions to be executed by the system processor 410. The system memory 415 can be used for storing temporary variables or other intermediate information during execution of instructions to be executed by the system processor 410. The system 105 further includes a system read-only-memory (ROM) 420 or other static storage device coupled to system bus 405 for storing static information and instructions for the system processor 410.

A system storage unit 425, such as a magnetic disk, optical disk, or a solid-state disk, is provided and coupled to the system bus 405 to store information. Examples of the information include, but are not limited to, a type of each machine, for example, 110-1 (see FIG. 1) employed in the worksite 100, a utility associated with each machine, a current location of each machine in each production circuit, for example, C1 (see FIG. 1), a current distance between the machines in each production circuit, and a current speed of each machine in each production circuit, one or more tasks or operations assigned or to be performed by each machine, the tasks or operations completed by each machine, a machine identification associated with each machine, an operator assigned to each machine or each electronic device (not shown) associated with each machine, device identification associated with each electronic device, operator identification, a map of the worksite 100, information related to the production circuits, for example, C1-C7 (see FIG. 3) in the worksite 100, the paths, for example, P1-P7 (see FIG. 3) included in each production circuit, and the locations, for example, L1-L9 (see FIGS. 1-3) provided along each path in each production circuit, geographical positions of the locations, for example, L1-L9 on the map, and a count of the machines in each production circuit, and/or machine cycle time for each production circuit. Examples of the information related to the production circuits include, but are not limited to, a count of production circuits, and a proximity of each production circuit to at least one predefined location, for example, D1 (see FIG. 1) within the worksite 100. Examples of the information related to the paths, for example, P1-P7, include, but are not limited to, a count of the paths in each production circuit, and a count of the machines assigned or operating in each path. Examples of the information related to the locations, for example, L1-L9, include, but are not limited to, a type or purpose of each location, a count of the locations, and a proximity of the locations with respect to each other and/or the predefined location within the worksite 100. In embodiments, the system storage unit 425 may also store one or more machine learning, artificial intelligence, logical, and/or conditional modules, algorithms, and/or models including, but not limited to, heuristic models, linear programming models, stochastic models, reinforcement learning models, simulation models, and historical analysis models. It may be understood that the information stored in the system storage unit 425 may be accessed by the system processor 410 via the system memory 415 to perform one or more functions.

The system 105 can be coupled via the system bus 405 to a system display 430, such as a light emitting diode (LED) and a liquid crystal display (LCD) for displaying information to an operator of the system 105. A system input device 435 is coupled to system bus 405 for communicating information and command selections to the system processor 410. The system input device 435 may be included in the system display 430, for example a touch screen that facilitates detection of multi-touch inputs from the user via the system display 430. The system input device 435 may also correspond to peripheral input devices that may be paired with the system 105 via Bluetooth, Wi-Fi, Wi-Fi direct, or as a hardware connection such a USB peripheral to the system 105. Examples of the peripheral input devices include, but are not limited to, a joystick, a gamepad, a keyboard, a mouse, a gesture-controlled device, or a wearable device such as, for example, a smart watch. In embodiments, the system input device 435 may also correspond to a microphone (not shown) provided in the system 105 that is configured to received audio inputs or instructions from the operator(s) of the system 105. In embodiments, the system input device 435 may also include alphanumeric and other keys. Another type of user input device is a system input control 440, such as a mouse, a trackball, or cursor direction keys for communicating direction information and command selections to the system processor 410 and for controlling cursor movement on the system display 430.

Various embodiments are related to the use of system 105 for implementing the techniques described herein. In one embodiment, the techniques are performed by the system 105 in response to the system processor 410 executing instructions included in the system memory 415. Such instructions can be read into the system memory 415 from another machine-readable medium, such as the system storage unit 425. Execution of the instructions included in the system memory 415 causes the system processor 410 to perform the process steps described herein.

The term “machine-readable medium” as used herein refers to any medium that participates in providing data that causes a machine to operate in a specific fashion. In an embodiment implemented using the system 105, various machine-readable medium is involved, for example, in providing instructions to the system processor 410 for execution. The machine-readable medium can be a storage media. Storage media includes both non-volatile media and volatile media. Non-volatile media includes, for example, optical, solid-state, or magnetic disks, such as the system storage unit 425. Volatile media includes dynamic memory, such as the system memory 415. All such media must be tangible to enable the instructions carried by the media to be detected by a physical mechanism that reads the instructions into a machine. Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip, or cartridge.

In another embodiment, the machine-readable medium can be a transmission media including coaxial cables, copper wire and fibre optics, including the wires that include the system bus 405. Transmission media can also take the form of acoustic or light waves, such as those generated during radio-wave and infra-red data communications. Examples of machine-readable medium may include, but are not limited, to a carrier wave as described hereinafter or any other medium from which the system 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the system 105 can receive the data on the telephone line and use an infra-red transmitter to convert the data to an infra-red signal. An infra-red detector can receive the data carried in the infra-red signal and appropriate circuitry can place the data on the system bus 405. The system bus 405 carries the data to the system memory 415, from which the system processor 410 retrieves and executes the instructions. The instructions received by the system memory 415 can optionally be stored in the system storage unit 425 either before or after execution by the system processor 410.

The system 105 also includes a system transceiver 445 coupled to the system bus 405. The system transceiver 445 provides a two-way data communication coupling with the machines, for example, 110, 115, 125, 130, 135, 140, 145 and/or the electronic devices (not shown) associated with the machines, for example, 110, 115, 125, 130, 135, 140, 145. For example, the system transceiver 445 can be an integrated service digital network (ISDN) card or a modem to provide a data communication connection to a corresponding type of telephone line. As another example, the system transceiver 445 can be a local area network (LAN) card to provide a data communication connection to a compatible LAN. Wireless links can also be implemented. In any such implementation, the system transceiver 445 sends and receives radio, electrical, electromagnetic, or optical signals that carry digital data streams representing various types of information.

In embodiments, the system processor 410 may be capable of executing the computer instructions stored in the system memory 415 to perform one or more functions. In embodiments, the system processor 410 may include one or more modules 450-455 to perform the one or more functions. For example, the system processor 410 may include a determination module 450 and a coordination module 455. It may be understood that the modules 450-455 may correspond to and/or include hardware and/or software components respectively and may be configured to perform respective functions. It may also be understood that, in embodiments, the modules 450-455 may implement one or more machine learning, artificial intelligence, logical, and/or conditional operations, modules, algorithms, and/or models stored in the system storage unit 425 to perform respective functions.

In embodiments, the determination module 450 is configured to determine a machine cycle time for completion of at least one task in at least one production circuit, for example, C1. The machine cycle time corresponds to a time taken by each machine, for example, 110-1 of at least one set of machines, for example, 110-1 through 110-6, to complete the at least one task in each production circuit, for example, C1 once. For example, the at least one task may correspond to loading and dumping of materials from a first location, for example, L1 (see FIG. 1) to a second location, for example, L2 (see FIG. 1) along the at least one path, for example, P1 (see FIG. 1) in a production circuit, for example, C1. The machine cycle time may then correspond to the time taken by the machine, for example, 110-1 to complete the task of loading and dumping of the materials from the first location, for example, L1 to the second location, for example, L2 once. As another example, the at least one task may correspond to charging the at least one set of machines, for example, 110-1 through 110-6 to a predefined target state of charge at one or more locations, for example, the charging locations such as the location L3. The machine cycle time may then correspond to the time taken by the machine, for example, 110-1 to charge up to the predefined target state of charge at the location, for example, L3. In embodiments, the determination module 450 may also be configured to receive the machine cycle time for at least one production circuit, for example, C1 via the system input device 435.

In embodiments, the at least one task corresponds to a first task and a second task, the at least production circuit corresponds to the first production C1 circuit and the second production circuit C2, and the at least one set of machines corresponds to the first set of machines, for example, 110-1 through 110-6 assigned to perform the first task in the first production circuit C1 and the second set of machines, for example, 115-1 through 115-9 assigned to perform the second task in the second production circuit C2. In embodiments, the first production circuit C1 includes at least one path, for example, the first path P1 traversed by the first set of machines, for example, 110-1 through 110-6 to complete the first task. Similarly, the second production circuit C2 includes at least one path, for example, the second path P2 traversed by the second set of machines, for example, 115-1 through 115-9 to complete the second task. In embodiments, the determination module 450 is configured to determine a first machine cycle time for completion of the first task in the first production circuit C1 and a second machine cycle time for completion of the second task in a second production circuit C2. In embodiments, the determined first machine cycle time to complete the first task in the first production circuit C1 by a first set machine, for example, 110-1 is same as or different from the second machine cycle time to complete the second task in the second production circuit C2 by a second set machine, for example, 115-1.

In embodiments, the determination module 450 is also configured to determine a count of the at least one set of machines, for example, 110-1 through 110-6, assigned to perform the at least one task in the at least one production circuit, for example, C1. For example, the determination module 450 is configured to determine a first count of the first set of machines, for example, 110-1 through 110-6 assigned to perform the first task and a second count of the second set of machines, for example, 115-1 through 115-9 assigned to perform the second task. In embodiments, the determined first count of the first set of machines, for example, 110-1 through 110-6, operating in the first production circuit C1 is less than, greater than, or equal to the determined second count of the second set of machines, for example, 115-1 through 115-9 operating in the second production circuit. In embodiments, the determination module 450 may also be configured to receive the count of the at least one set of machines assigned to perform the at least one task in at least one production circuit, for example, C1 via the system input device 435.

In embodiments, the determination module 450 is configured to implement the one or models, for example, the cost model to determine the planned count of machines of the at least one set of machines, for example, 110-1 through 110-6, from the at least one production circuit, for example, C1, targeted to be present at a predefined location, for example, L2 or D1, along or proximate to the at least one path, for example, P1, in the at least one production circuit at a predefined time or during a predefined time period based on production requirements. In embodiments, the predefined location is same or different for each machine of the at least one set of machines, for example, 110-1 through 110-6, in the at least one production circuit, for example, C1. In embodiments, the predefined location is same or different for the different sets of machines, for example, 110-1 through 110-6, and 115-1 through 115-9, in different production circuits, for example, C1 and C2. In embodiments, the determination module 450 is also configured to determine the planned count of different sets of machines, for example, 110-1 through 110-6 and 115-1 through 115-9, from different production circuits, for example, C1 and C2 in each determined cluster, for example, G1 targeted to be present at the predefined or same location, for example, D1, along or proximate to the at least one path, for example, P1, at the predefined time or during the predefined time period. In embodiments, the predefined time or time period is same or different for different machines, for example, 110-1, 115-1, in different sets of machines, for example, 110-1 through 110-6, 115-1 through 115-9, and in different production circuits, for example, C1, C2. In embodiments, the determination module 450 is also configured to determine a ratio of the planned count of machines from the different sets of machines, for example, 110-1 through 110-6 and 115-1 through 115-9, and from different production circuits, for example, C1 and C2 in each determined cluster, for example, G1, targeted to be present at the predefined or same location along or proximate to the at least one path, for example, P1, P2 at the predefined time or during the predefined or same time period. In embodiments, the determination module 450 may also be configured to receive the planned count or the ratio of the planned count of the machines from different production circuits targeted to be present at the predefined or same location at the predefined time or during the predefined or same time period via the system input device 435. In embodiments, the determination module 450 may also be configured to receive the predefined location and/or the predefined time or time period via the system input device 435. In embodiments, the predefined location for the production circuits, C1, C2 in the determined cluster, for example, G1, corresponds to different locations, for example, the location L2 in the first production circuit C1 and the location L5 in the second production circuit C2, or the same location, for example, D1, for the different sets of machines, for example, the first set of machines, for example, 110-1 through 110-6, and the second set of machines, for example, 115-1 through 115-9, in the different production circuits, for example, C1, C2. In embodiments, the determination module 450 may also be configured to receive the planned count or the ratio of the planned count of machines of the at least one set of machines in the at least one production circuit, for example, C1 targeted to be present at the predefined or same location at the predefined time or during the predefined or same time period via the system input device 435. In embodiments, the determination module 450 may also be configured to receive the predefined location and/or the predefined time or time period corresponding to at least one production circuit and/or the determined cluster(s), for example, G1, G2 respectively via the system input device 435. For example, the determination module 450 is configured to receive the planned count of 1 first set machine, for example, 110-1 targeted to be present at the location L2 at the predefined time or during the predefined time period via the system input device 435, or receive the ratio of the planned count of 1 first set machine, for example, 110-1 carrying a first type of material and 1 first set machine, for example, 110-2 carrying a second type of material targeted to be present at the location D1 at the predefined time or during the predefined time period via the system input device 435. Similarly, the determination module 450 is configured to receive the planned count of 1 first set machine, for example, 110-1 of the first set of machines, for example, 110-1 through 110-6 from the first production circuit C1, and 2 second set machines, for example, 115-1, 115-2 of the second set of machines, for example, 115-1 through 115-9 from the second production circuit C1 targeted to be present at the location D1 at the predefined time or during the predefined time period via the system input device 435. In embodiments, the planned count or the ratio of the planned count received via the system input device 435 is based on worksite events and/or current production changes or requirements. It will be apparent that the determination module 450 is also configurable to receive the planned count or the ratio of the planned count automatically via one or more internal or external control systems (not shown) associated with the worksite events and/or production such as, but not limited to, stand-alone modules or applications provided in the system 105 or one or more external electronic devices (not shown) in communication with the determination module 450 of the system 105 via the system transceiver 445.

As an example, the determination module 450 is configured to determine a first planned count of 1 first set machine or 2 first set machines of the first set of machines, for example, 110-1 through 110-6 targeted to be present at the location L2 along the path, for example, P1 at the predefined time or during the predefined time period in the first production circuit C1. Similarly, the determination module 450 is configured to determine a second planned count of 1 second set machine or 2 second set machines of the second set of machines, for example, 115-1 through 115-9 targeted to be present at the location L5 along the path, for example, P2 at the predefined time or during the predefined time period in the second production circuit C2. As another example, in the determined cluster G1 including the first production circuit C1 and the second production circuit C2, the determination module 450 is configured to determine the first planned count of 1 first set machine of the first set of machines, for example, 110-1 through 110-6 and the second planned count of 2 second set machines of the second set of machines, for example, 115-1 through 115-9 targeted to be present at the same location, for example, D 1, proximate to the paths P1, P2 of the production circuits C1, C2 or at different locations, for example, L2 and L5 along the paths P1, P2 respectively, at the predefined time or during the predefined or same time period. The determination module 450 is also configured to determine the ratio of the first planned count of the first set of the machines and the second planned count the second set of machines targeted to be present at the same location, for example, D1, during the same time period. For example, the determination module 450 is also configured to determine the ratio of one first set machine of the first set of machines, for example, 110-1 through 110-6, for every two second set machines of the second set of machines, for example, 115-1 through 115-9 targeted to be present at the location D1 during the same time period. Similarly, determination module 450 is also configured to determine the ratio of the first planned count of the first set of the machines and the second planned count the second set of machines targeted to be present at different locations, for example, the location L2 for the first set of machines and the location L5 for the second set of machines, during the same time period. For example, the determination module 450 is also configured to determine the ratio of one first machine of the first set of machines, for example, 110-1 through 110-6, targeted to be present at the location, for example, L2 for every two second set machines of the second set of machines, for example, 115-1 through 115-9 targeted to be present at the location, for example, L5 during the same time period. In embodiments, the determined ratio between the first set of machines, for example, 110-1 through 110-6 and the second set of machines, for example, 115-1 through 115-9 is represented as 1:2 to indicate 1 first set machine for every 2 second set machines targeted to be present at the predefined or same location at the predefined time or during the predefined or same time period.

As another example, the determination module 450 is configured to determine a third planned count of 1 third set machine or 2 third set machines of the third set of machines, for example, 125-1 through 125-3 targeted to be present at the location L9 along the path, for example, P3 (see FIG. 2) at the predefined time or during the predefined time period in the third production circuit C3. Similarly, the determination module 450 is configured to determine a fourth planned count of 1 fourth set machine or 2 fourth set machines of the fourth set of machines, for example, 130-1 through 130-4 targeted to be present at the location L9 along the path, for example, P4 (see FIG. 2) at the predefined time or during the predefined time period in the fourth production circuit C4. As another example, in the determined cluster, for example, G2 including the third production circuit C3 and the fourth production circuit C4, the determination module 450 is configured to determine the third planned count of 1 third set machine of the third set of machines, for example, 125-1 through 125-3 and the fourth planned count of 2 fourth set machines of the fourth set of machines, for example, 130-1 through 130-4 targeted to be present at the location L9 at the predefined time or during the predefined time period. The determination module 450 is also configured to determine the ratio of the third planned count of the third set of the machines, for example, 125-1 through 125-3 and the fourth planned count the fourth set of machines, for example, 130-1 through 130-4 targeted to be present at the location L9 during the same time period. For example, the determination module 450 is also configured to determine the ratio of 1 third set machine of the third set of machines, for example, 125-1 through 125-3, for every 2 fourth set machines of the fourth set of machines, for example, 130-1 through 130-4 targeted to be present at the location L9 during the same time period. In embodiments, the determined ratio between the third set machines, for example, 125-1 through 125-3 and the fourth set of machines, for example, 130-1 through 130-4 is represented as 1:2 to indicate 1 third set machine for every 2 fourth set machines targeted to be present at the predefined or same location, for example, L9 at the predefined time or during the predefined or same time period.

In yet another example, the determination module 450 is configured to determine a fifth planned count of 1 fifth set machine or 2 fifth set machines of the fifth set of machines, for example, 135-1 through 135-n targeted to be present at the location, for example, D2 proximate to the path, for example, P5 (see FIG. 3) at the predefined time or during the predefined time period in the fifth production circuit C5. Similarly, the determination module 450 is configured to determine a sixth planned count of 1 sixth set machine or 2 sixth set machines of the sixth set of machines, for example, 140-1 through 140-n targeted to be present at the location, for example, D2 proximate the path, for example, P6 (see FIG. 3) (at the predefined time or during the predefined time period in the sixth production circuit C6. The determination module 450 is also configured to determine a seventh planned count of 1 seventh set machine or 2 seventh set machines of the sixth set of machines, for example, 145-1 through 145-n targeted to be present at the location, for example, D2 proximate the path, for example, P7 (see FIG. 3) at the predefined time or during the predefined time period in the seventh production circuit C7. As another example, in the determined cluster, for example, G3 including the fifth production circuit C5, the sixth production circuit C6, and the seventh production circuit C7, the determination module 450 is configured to determine the fifth planned count of 1 fifth set machine of the fifth set of machines, for example, 135-1 through 135-n, the sixth planned count of 2 sixth set machines of the sixth set of machines, for example, 140-1 through 140-n, and the seventh planned count of 2 seventh set machines of the seventh set of machines, for example, 145-1 through 145-n targeted to be present at the same location, for example, D2, proximate to the paths P5, P6, P7 of the production circuits C5, C6, C7 or at different locations (not shown) along the paths P5, P6, P7 respectively, at the predefined time or during the predefined time period. The determination module 450 is also configured to determine the ratio of the fifth planned count of the fifth set of the machines, for example, 135-1 through 135-n, the sixth planned count of the sixth set of machines, for example, 140-1 through 140-n, and the seventh planned count the seventh set of machines, for example, 145-1 through 145-n targeted to be present at the same location, for example, D2, during the same time period. For example, the determination module 450 is also configured to determine the ratio of 1 fifth machine of the fifth set of machines, for example, 135-1 through 135-n, for every 2 sixth set machines of the sixth set of machines, for example, 140-1 through 140-n, and 2 seventh set machines of the seventh set of machines, for example, 145-1 through 145-n targeted to be present at the location D2 during the same time period. In embodiments, the determined ratio is ratio between the fifth set of machines, for example, 135-1 through 135-n, the sixth set of machines, for example, 140-1 through 140-n, and the seventh set of machines, for example, 145-1 through 145-n is represented as 1:2:2 to indicate 1 fifth set machine for every 2 sixth set machines and 2 seventh set machines targeted to be present at the predefined or same location, for example, D2 at the predefined time or during the predefined or same time period.

In embodiments, the determination module 450 is configured to determine the planned count of the machines, for example, 110-1 through 110-6, in the at least one production circuit, for example, C1 or the ratio of the planned counts of the different sets of machines, for example, 110-1 through 110-6 and 115-1 through 115-9 targeted to be present at the predefined or the same location and/or during the same time period based on production requirements. Examples of the production requirements include, but are not limited to, a production rate of materials or each type of material and/or a blend compliance of the materials to be provided by the at least one set of machines from the at least one production circuit or multiple production circuits at the predefined or the same location at the predefined time or during the predefined or same time period. The production rate corresponds to a quantity of the materials or each type of material to be provided at the predefined or the same location by the at least one set of machines from the at least one production circuit or multiple production circuits at the predefined or the same location and at the predefined time or during the predefined or same time period. The blend compliance corresponds to a ratio of each type of material to be included in a mixture of the materials. In embodiments, the determination module 450 is also configured to determine a material loading capacity of each machine of the at least one set of machines, for example, 110-1 through 110-6 and determine the planned count based on the determined material loading capacity, determined productions requirements, the determined count of the at least one set of machines, for example, 110-1 through 110-6, and the determined machine cycle time for providing the materials between the locations, for example, L1 to L2 in the at least one production circuit, for example, C1. The material loading capacity of the machine, for example, 110-1 corresponds to an amount and/or a weight of the materials that can be loaded onto the machine.

For example, in the first production circuit C1, the determination module 450 may be configured to determine the production requirement of ‘X’ amount of a first type of material to be provided by the first set of machines, for example, 110-1 through 110-6, at the location, for example, L2 at the predefined time or during the predefined time period. The determination module 450 may be configured to determine the machine loading capacity of ‘Y’ amount of the first type of material for each first set machine, for example, 110-1. The determination module 450 is configured to determine the planned count of 1 first set machine of the first set of machines, for example, 110-1 through 110-6 to be present at the predefined location, for example, L2 or D1, based on the determined production requirement, the determined machine loading capacity, the determined first count of the first set of machines, for example, 110-1 through 110-6, and the determined machine cycle time for providing the first type of material between the locations, for example, L1 to L2 by each first set machine in the first production circuit C1.

In another example, in the determined cluster or group, G1, the determination module 450 may be configured to determine the blend compliance production requirement of ‘A’ amount of the first type of material to be provided by the first set of machines, for example, 110-1 through 110-6, at the location, for example, D1 proximate to the path, for example, P1 of the first production circuit C1 and ‘B’ amount of a second type of material to be provided by the second set of machines, for example, 115-1 through 115-9, at the location, for example, D1 proximate to the path, for example, P2 of the second production circuit C2 at the predefined time or during the predefined or same time period. The determination module 450 may be configured to determine the machine loading capacity of ‘C’ amount of the first type of material for each first set machine, for example, 110-1 and the machine loading capacity of ‘D’ amount of the second type of material for each second set machine, for example, 115-1. The determination module 450 is configured to determine the first planned count of 1 first set machine of the first set of machines, for example, 110-1 through 110-6 and the second planned count of 2 second set machines of the second set of machines, for example, 115-1 though 115-9, to be present at the predefined or same location, for example, D1, based on the determined blend compliance production requirement, the determined machine loading capacity, the determined first count of the first set of machines, for example, 110-1 through 110-6, the determined second count of the second set of machines, for example, 115-1 through 115-9, the determined first machine cycle time for providing the first type of material between the locations, for example, L1 to D1 by each first set machine, for example, 110-1 in the first production circuit C1, and the determined second machine cycle time for providing the second type of material between the locations, for example, L4 to D1 by each second set machine, for example, 115-1 in the second production circuit C2.

In embodiments, the determination module 450 is also configured to implement the one or models, for example, the cost model to determine a time duration of a distance to be maintained between the at least one set of machines, for example, 110-1 through 110-6, traversing along the at least one path, for example, P1, based on the determined machine cycle time, the determined count of the at least one set of machines, the determined ratio and/or the determined planned count. In embodiments, the time duration corresponds to a time taken by each machine, for example, 110-1 of the at least one set of machines, for example, 110-1 from a current location to travel or cover the distance to another location of another machine, for example, 110-2. In embodiments, determination module 450 is configured to determine the time duration by dividing the determined machine cycle time corresponding to the at least one production circuit, for example, C1, with the determined count of the at least one set of machines, for example, 110-1 through 110-6 assigned to perform the at least one task in the at least one production circuit, for example, C1. For example, for instances when the determined first count of the first set of machines, for example, 110-1 through 110-6, assigned to the first production circuit C1 corresponds to 6 and the determined machine cycle time corresponding to the first production circuit C1 corresponds to 18 minutes per cycle per machine in the first production circuit C1, the determined time duration of distance between the first set of machines, for example, 110-1 through 110-6, corresponds to 3 minutes. Similarly, for instances when the determined third count of the third set of machines, for example, 125-1 through 125-3, assigned to the third production circuit C3 corresponds to 3 and the determined machine cycle time corresponding to the third production circuit C3 corresponds to 9 minutes per cycle per machine in the third production circuit C3, the determined time duration of distance between the first set of machines, for example, 110-1 through 110-6, corresponds to 3 minutes. In embodiments, the determined time duration of the distance between the at least one set of machines, for example, 110-1 through 110-6 is same or different. In embodiments, a sum of the determined time duration is less than, equal to, or greater than the determined machine cycle time.

For example, the determination module 450 is configured to determine a first time duration of the distance to be maintained between the first set of machines, for example, 110-1 through 110-6 traversing along the path, for example, P1, based on the determined first machine cycle time, the determined first count of the first set of machines for example, 110-1 through 110-6 and/or the first planned count of 1 first set machine of the first set of machines for example, 110-1 through 110-6, targeted to be present at the predefined location at the predefined time or during the predefined time period. Similarly, the determination module 450 is configured to determine a second time duration of the distance to be maintained between the second set of machines, for example, 115-1 through 115-9 traversing along the path, for example, P2, based on the determined second machine cycle time, the determined second count of the first set of machines for example, 110-1 through 110-6, and/or the determined second planned count of 2 second set machines of the second set of machines for example, 115-1 through 115-9, targeted to be present at the predefined location at the predefined time or during the predefined time period.

In another example, the determination module 450 is configured to determine the first time duration of the distance to be maintained between the first set of machines, for example, 110-1 through 110-6 traversing along the path, for example, P1, in the first production circuit C1 and the second time duration of the distance to be maintained between the second set of machines, for example, 115-1 through 115-9 traversing along the path, for example, P2, in the second production circuit C2 based on the determined first machine cycle time, the determined first count, the determined second machine cycle time, the determined second count, the determined ratio, the determined first planned count of 1 first set machine targeted to be present at the predefined or same location, for example, D1, and/or the determined second planned count of 2 second set machines targeted to be present at the predefined or same location, for example, D1 at the predefined time or during the predefined or same time period. In embodiments, the determined first time duration of the distance between the first set of machines, for example, 110-1 through 110-6 operating in the first production circuit C1 is less than, greater than, or equal to the determined second time duration of the distance between the second set of machines, for example, 115-1 through 115-9 operating in the second production circuit C2.

In embodiments, the determination module 450 is also configured to determine the time duration of the distance to be maintained between the at least one set of machines, for example, 110-1 through 110-6, based on an estimated time period and/or an estimated time duration of or between an availability of electrical power at one or more machine charging locations, for example, L3 provided with, for example, the dynamic charging trolleys along the at least one path, for example P1 in at least one production circuit, for example, C1. In embodiments, the determination module 450 is also configured to determine the time duration of the distance between the at least one set of machines, for example, 110-1 through 110-6 such that at least one machine of the at least one set of machines is present at the machine charging location(s), for example, L3 during the estimated time period and/or the estimated time duration at the machine charging location(s).

In embodiments, the coordination module 455 is configured to coordinate movement of the at least one set of machines, for example, 110-1 through 110-6 traversing along the at least one path, for example, P1 based on the determined machine cycle time and the determined time duration of the distance such that the planned count of the at least one set of machines, for example, 110-1 through 110-6, is present at the predefined or same location, for example, L2 or D1 along or proximate to the at least one path, for example, P1 at the predefined time or during the predefined time period. In embodiments, the coordination module 455 is configured to coordinate the movement such that a physical separation or the distance is maintained between the at least one set of machines, for example, 110-1 through 110-6, based on the determined time duration. In embodiments, the coordination module 455 is configured to coordinate the movement between different sets of machines in different production circuits such that the planned count of the machines in the different set of machines respectively are present at the predefined or same location at the predefined time or during the predefined or same time period. In embodiments, the coordination module 455 is configured to coordinate the movement between different sets of machines in different production circuits based on the determined ratio. For example, the coordination module 455 is configured to coordinate the first movement between the first set of machines, for example, 110-1 through 110-6 traversing along the first path, of example, P1 in the first production circuit C1 based on the determined first time duration and the movement between the second set of machines, for example, 115-1 through 115-9 traversing along the second path, for example, P2 in the second production circuit C2 based on the determined second time duration such that the first planned count of the first set of machines and the second planned count of the second set of machines are present at the predefined or same location, for example, D1, at the predefined time or during the predefined or same time period according to the determined ratio.

In embodiments, the coordination module 455 is configured to implement the one or more models including, but not limited to, a cost model associated with the at least one production circuit, for example, C1 stored in the storage unit 425 to optimize movement of each machine of the at least one set of machines, for example, 110-1 through 110-6 in the at least one production circuit. In embodiments, the coordination module 455 is configured to optimize the movement of each machine such that the planned count of machines of the at least one set of machines, for example, 110-1 through 110-6, from the at least one production circuit, for example, C1, is present at the predefined location, for example, L2 or D1, along or proximate to the at least one path, for example, P1, in the at least one production circuit at a predefined time or during a predefined time period based on production requirements. In embodiments, the coordination module 455 is also configured to optimize the movement of each machine such that a substantially consistent time duration of a distance is maintained between the at least one set of machines, for example, 110-1 through 110-6, traversing along the at least one path, for example, P1, based on the determined machine cycle time, and/or the determined count of the at least one set of machines. In embodiments, the coordination module 455 is also configured to implement, for example, the cost model to optimize the movement of each machine in the at least one production circuit, for example, C1 such that at least one machine of the at least one set of machines, for example, 110-1 through 110-6 is present at the predefined location such as the charging location, for example, L3 having the stationary charging stations and/or the dynamic charging trolleys provided at the charging location(s), for example, L3 along the at least one path, for example, P1 during predefined time period(s) of available electrical power at the stationary charging stations and/or the dynamic charging trolleys.

In embodiments, the coordination module 455 is configured to receive at least one input from the machines, for example, 110, 115, 125, 130 via the network 120. Examples of the at least one input include, but are not limited to, a type of each machine, a location of each machine within the worksite 100, the production circuit assigned to each machine, one or more machine operating parameters associated with each machine, the task assigned to each machine, and/or a current machine status of each machine. Examples of the machine operating parameters include, but are not limited to, a ground or engine speed of each machine, and/or a current load carried by each machine. Examples of the current machine status include, but are not limited to, performing loading, transporting, and/or dumping the load by each machine. In embodiments, the coordination module 455 is also configured to determine at least one current production status of the at least one production circuit, for example, C1 based on the at least one received input. Examples of the at least one current production status include, but are not limited to, a current time duration of distance between the at least one set of machines, a current speed of the at least one set of machines, a current count and/or location of the at least one set of machines present at each location along the at least one path, for example, P1 in the at least one production circuit, for example, C1, and/or a current amount of material being loaded, transported, or provided by the at least one machine of the at least one set of machines at the predefined location, for example, D1. In embodiments, the coordination module 455 is configured to provide instructions to the at least one set of machines, for example, 110-1 through 110-6 via the network 120 respectively to coordinate the movement. In some embodiments, the coordination module 455 is configured to provide instructions to one or more electronic devices (not shown) including, but not limited to, mobile devices, electronic tablets, and/or remote-control systems associated with at least one machine, for example, 110-1 of the at least one set of machines, for example, 110-1 through 110-6, via the network 120 respectively to coordinate the movement. In embodiments, the coordination module 455 is configured to provide the instructions based on the at least one received input and/or the at least one determined current production status.

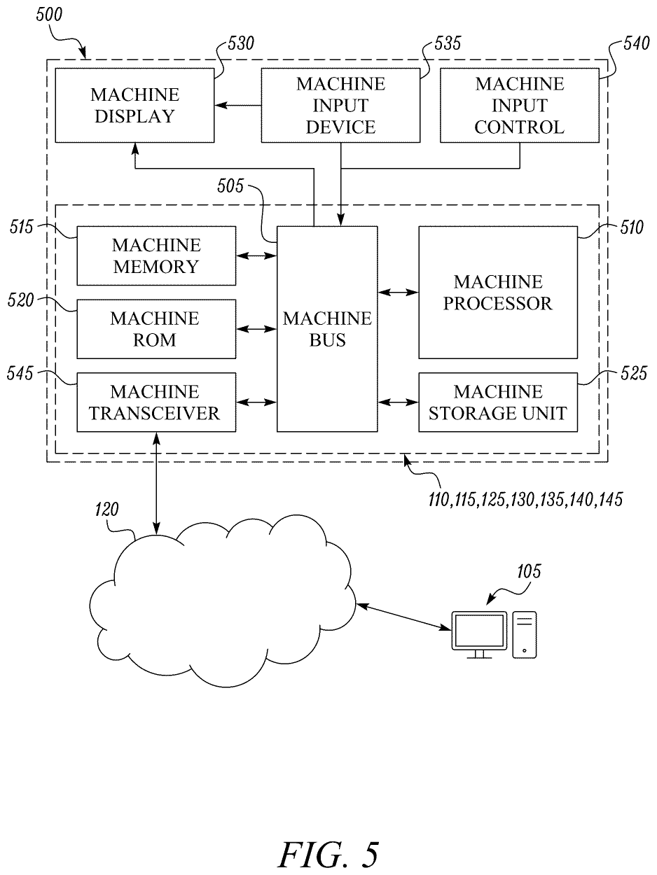

Referring to FIG. 5, it will be understood by those with ordinary skill in the art that each machine, for example, 110-1 of the at least one set of machines, for example, 110-1 through 110-6, and/or the machines 110, 115, 125, 130, 135, 140, and/or 145 may include a machine system 500 having machine components 505-545 similar to the system components 405-445 of the system 105 respectively. It may also be understood by those with ordinary skill in the art that the machine components 505-545 may be configured to perform similar functions as the system components 405-445 of the system 105. For example, each machine, for example, 110-1 includes the machine system 500 having a machine bus 505, a machine processor 510, a machine memory 515, a machine ROM 520, a machine storage unit 525, a machine display 530, a machine input device(s) 535, a machine input control 540, and a machine transceiver 545. In embodiments, the machine processor 510 of each machine, for example, 110-1 is configured to provide the at least one input including, but are not limited to, the type of the machine, the location of the machine within the worksite 100, the production circuit assigned to the machine, the one or more machine operating parameters associated with the machine, the task assigned to the machine, and/or the current machine status of the machine. In embodiments, the machine processor 510 of each machine, for example, 110-1 is also configured to receive the instructions from the system 105 via the network 120 and the machine transceiver 545, and perform one or more functions including, but not limited to, regulating a ground speed or an engine speed of the corresponding machine, controlling a direction of movement of the corresponding machine, directing the corresponding machine to one or more locations, for example, L2 or D1, along or proximate to at least one path, for example P1, in the at least one production circuit within the worksite 100, and/or directing the corresponding machine to different paths in different production circuits within the worksite 100. In embodiments, the machine processor 510 is also configured to provide the received instructions on the machine display 530. In embodiments, the instructions provided on the machine display 530 may enable an operator of the corresponding machine to provide one or more inputs/commands to the machine processor 510 and initiate one or more machine operations associated with, but not limited to, the ground or engine speed, the direction of movement, and/or directions to the predefined location.

Similarly, it will be understood by those with ordinary skill in the art that each machine, for example, 110-1 of the at least one set of machines, for example, 110-1 through 110-6, may be associated with the corresponding electronic device (not shown) including, but not limited to, a mobile phone of the operator operating the corresponding machine. The electronic device may include device components similar to the machine components 505-545 of the machine system 500. It may also be understood by those with ordinary skill in the art that the device components may be configured to perform similar functions as the machine system components 505-545 of the machine system 500. For example, the electronic device may also include a device bus, a device processor, a device memory, a device ROM, a device storage unit, a device display, a device input device(s), a device input control, and a device transceiver. In embodiments, the device processor of the electronic device associated with each machine, for example, 110-1 may also be configured to receive the instructions from the system 105 via the network 120 and the device transceiver, and perform one or more functions including, but not limited to, directing an operator using the electronic device to regulate a ground speed or an engine speed of the corresponding machine, control a direction of movement of the corresponding machine, direct the corresponding machine to one or more locations, for example, L2 or D1, along or proximate to at least one path, for example P1, in the at least one production circuit within the worksite 100, and/or direct the corresponding machine to different paths in different production circuits within the worksite 100. In embodiments, the device processor may be configured to provide the received instructions on the device display. In embodiments, the instructions provided on the device display may enable the operator to provide one or more inputs/commands to the machine, for example, 110-1 and initiate one or more machine operations associated with, but not limited to, the ground or engine speed, the direction of movement, and/or directions to the predefined location.

Referring again to FIG. 4, in embodiments, the coordination module 455 is also configured to coordinate the movement of the at least one set of machines, for example, 110-1 through 110-6 by maintaining the determined time duration of the distance between the at least one set of machines, for example, 110-1 through 110-6 traversing along the at least one path, for example, P1. In embodiments, the coordination module 455 is also configured to maintain the determined time duration between different sets of machines in different production circuits respectively such that the planned count of the machines in the different set of machines respectively are present at the predefined or same location at the predefined time or during the predefined or same time period. For example, the coordination module 455 is configured to maintain the determined first time duration between the first set of machines, for example, 110-1 through 110-6 and the determined second time duration between the second set of machines, for example, 115-1 through 115-9 such that the first planned count of the first set of machines and the second planned count of the second set of machines are present at the predefined or same location, for example, the location D1, at the predefined time or during the predefined or same time period according to the determined ratio. In embodiments, the determined time duration maintained between the at least one set of machines, for example, 110-1 through 110-6, may be same or different. For example, the coordination module 455 is configured to maintain the same determined time duration of 1 minute between the first set of machines, for example, 110-1 and 110-6 respectively. As another example, the coordination module 455 is also configured to maintain the determined time duration of 2 minutes between the first set machines, for example, 110-1 and 110-2, and the determined time duration of 1 minute between the first set machines, for example, 110-2 and 110-3.

In embodiments, the coordination module 455 is also configured to maintain the determined time duration of distance between different sets of machines in different production circuits respectively such that at least one machine of the at least one set of machines in each production circuit is present at one or more locations, for example, L3 designated for machine charging, in each production circuit during the estimated time period and/or the estimated time duration of the availability of electrical power at the location(s). For example, an estimated time duration between the availability of electrical power at the location, for example, L3 is, for example, equal to or approximately 10 minutes. The coordination module 455 is configured to maintain the time duration of distance of, for example, 10 minutes between the first set machines, for example, 110-1 and 110-6 in the first production circuit, for example, C1 such that after the first set machine 110-2 traverses past the location, for example, L3 post charging of the first set machine 110-2 via, for example, the dynamic charging trolley at the location, for example, L3, the first set machine 110-1 is present at the location, for example, L3 for charging of the first set machine 110-1 after the estimated time duration of 10 minutes.

In embodiments, the coordination module 455 is also configured to coordinate the movement of the at least one set of machines, for example, 110-1 through 110-6 by regulating a speed of travel of at least one machine, for example, 110-1 of the at least one set of machines, for example, 110-1 through 110-6 traversing along the at least one path, for example, P1. For example, the coordination module 455 is configured to reduce or increase the ground or engine speed of the first set machine, for example, 110-1 from a first speed to a second speed. In embodiments, the coordination module 455 is also configured to determine the current speed of each machine, for example, 110-1 based on the at least one received input from each machine, for example, 110-1 and coordinate the movement of each machine based on the determined current speed. For example, the coordination module 455 is configured to direct the first set machine, for example, 110-1 travelling at a speed greater than the first set machine, for example, 110-2 to move past the first set machine, for example 110-2 along the first path, P1 in the first production circuit C1. In embodiments, the coordination module 455 is configured to direct the first set machine, for example, 110-2 to allow the first machine, for example, 110-1 to move past the first set machine, for example, 110-2 based on the determined current speed of the first set machines, for example, 110-1 and 110-2 respectively.

In embodiments, the coordination module 455 is also configured to coordinate the movement of the at least one set of machines, for example, 110-1 through 110-6 by directing the at least one machine, for example, 110-1 to at least one location, for example, the location L2 (see FIG. 1) or the location L3 (see FIG. 1) within the at least one production circuit, for example, C1 or for example, the location D1, that is outside the at least one production circuit, for example, C1. In embodiments, the coordination module 455 is also configured to coordinate the movement by directing the at least one machine, for example, 110-1 between different production circuits to perform different tasks. In embodiments, the coordination module 455 is also configured to direct the at least one machine, for example, 110-1 between the production circuits associated with the determined cluster(s) or group(s), for example, G1 of the production circuits, for example, C1, C2. For example, the coordination module 455 is configured to direct the first set machine, for example, 110-1 from the first production circuit C1 to perform the second task in the second production circuit C2 or the second set machine, for example, 115-1 from the second production circuit C2 to perform the first task in the first production circuit C1. It may be understood by those with ordinary skill in the art that for instances when the first set machine, for example, 110-1 is directed to perform the second task in the second production circuit C2, the second count of the second set of machines includes the first set machine performing the second task and the coordination module 455 is configured to coordinate the movement of the second set of machines, for example, 115-1 through 115-9 and the first set machine, for example, 110-1 performing the second task in the second production circuit C2 such that the second planned count of the second set of machines, for example, 115-1 through 115-9 including the first set machine, for example, 110-1 is present at the predefined location, for example, L5 or D1. Similarly, for instances when the second set machine, for example, 115-1 is directed to perform the first task in the first production circuit C1, the first count of the first set of machines includes the second set machine, for example, 115-1 performing the first task and the coordination module 455 is configured to coordinate the movement of the first set of machines, for example, 110-1 through 110-6 and the second set machine, for example, 115-1 performing the first task in the first production circuit C1 such that the first planned count of the first set of machines, for example, 110-1 through 110-6 including the second set machine, for example, 115-1 is present at the predefined location, for example, L2 or D1.

In embodiments, the coordination module 455 is also configured to coordinate the movement of the at least one set of machines, for example, 110-1 through 110-6 by redirecting the at least one machine, for example, 110-1 previously directed to perform different tasks in different production circuits, for example, C2 back to the production circuit, for example C1 originally assigned to the at least one machine, for example, 110-1. For example, the coordination module 455 is configured to redirect the first set machine, for example, 110-1 previously directed to the second production circuit C2 to perform the second task back to the first production circuit C1 originally assigned to the first set machine, for example, 110-1 to perform the first task. Similarly, the coordination module 455 is also configured to redirect the second set machine, for example, 115-1 previously directed to the first production circuit C1 to perform the first task back to the second production circuit C2 originally assigned to the second set machine, for example, 115-1 to perform the second task.

In embodiments, the coordination module 455 is configured to direct or redirect the at least machine between the different production circuits, for example, C1, C2 in the determined cluster, for example, G1 based on the at least one received input from the at least one machine including, but not limited to, the current status of the at least one machine and/or the determined current time duration of distance between the at least one set of machines, for example, 110-1 through 110-6. For example, the coordination module 455 is configured to determine that the first set machine, for example, 110-1 is currently idle or stationed at a location, for example, L1 along the path P1 in the first production circuit C1, or that the determined current time duration of distance between the first set machine, for example, 110-1 and another first set machine, for example, 110-2 is less than a predefined threshold, and then direct the first set machine, for example, 110-1 to perform the second task in the second production circuit C2 based on the determined current status and/or the determined current time duration of distance. Similarly, the coordination module 455 is configured to direct one or more of the machines in each set of machines, for example, 110-1 through 110-6 and 115-1 through 115-9, between the different production circuits, for example, C1 and C2 based on the at least one determined current production status associated with the different production circuits, for example, C1 and C2.

In embodiments, the coordination module 455 is also configured to coordinate the movement of the at least one set of machines, for example, 110-1 through 110-6 by directing the at least one machine, for example, 110-1 between different production circuits to perform different tasks based on the determined count of the at least set of machines in each production circuit and/or the determined ratio of the planned count of the at least one set of machines corresponding to each production circuit targeted to be present at the predefined or same location, for example, D1 at the predefined time or during the predefined or same time period. In embodiments, the coordination module 455 is also configured to coordinate the movement by directing at least one machine from a production circuit having a greater determined count of the at least one set of machines assigned to the production circuit to another production circuit having a lesser determined count of the at least one set of machines assigned to another production circuit in comparison.

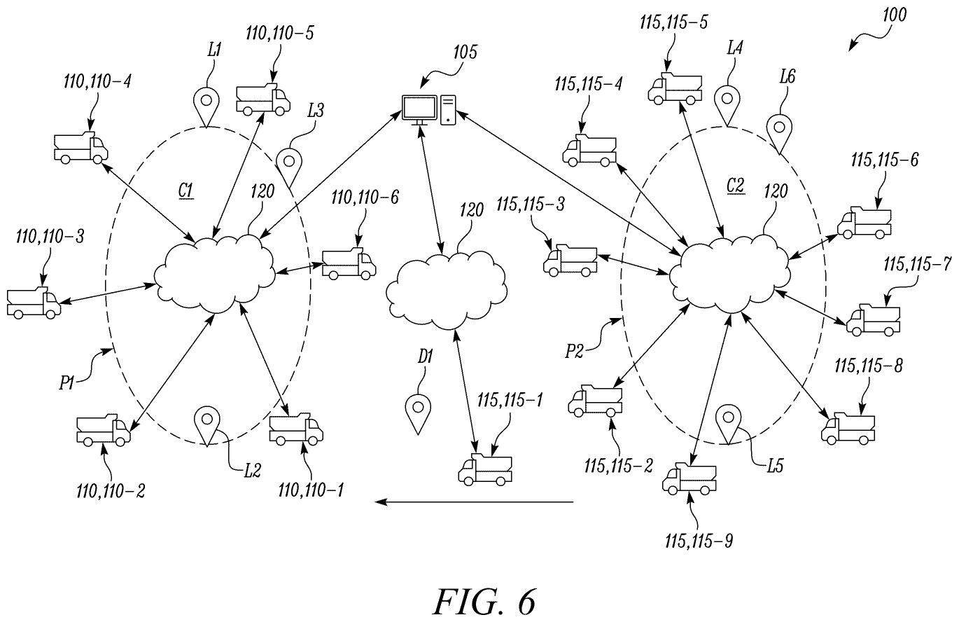

For example, as shown in FIG. 6, for instances when the determined count of the first set of machines, for example, 110-1 through 110-6 assigned to perform the first task in the first production circuit C1 corresponds to 6 and the determined count of the second set of machines, for example, 115-1 through 115-9 assigned to perform the second task in the second production circuit C2 corresponds to 9, and the determined ratio is 2 first set machines for every 1 second set machine at the predefined location, for example, D1 during the same time period, the coordination module 455 is configured to direct one or more second set machines, for example, 115-1 to perform the first task in the first production circuit C1 such that the determined ratio of the planned count of machines from the different production circuits, for example, C1, C2 are present at the predefined or same location, for example, D1 at the predefined time or during the predefined or same time period.

Referring again to FIG. 4, in embodiments, the coordination module 455 is also configured to coordinate the movement of the at least one set of machines, for example, 110-1 through 110-6 by stationing the at least one machine, for example, 110-1 at a location, for example, L3 or directing the at least one machine, for example, 110-1 to halt at the location, for example, L3, along the at least one path, for example, P1 for a predetermined time period. In embodiments, the coordination module 455 is configured to station or direct the at least one machine, for example, 110-1 to halt at the location, for example, L3 to maintain the determined time duration of distance between the at least one machine, for example, 110-1 and another machine, for example, 110-2 that is ahead or further along the at least one path, for example, P1 in the at least one production circuit, C1. In embodiments, the coordination module 455 is also configured to station the at least one machine or direct the at least one machine to halt at a location based on the at least one received input including, but not limited to, the current speed of each machine, and/or the current location of each machine, from the at least one set of machines in the at least one production circuit.

In embodiments, the coordination module 455 is also configured to monitor an actual count of the at least one set of machines, for example, 110-1 through 110-6 present at the predefined location such as the loading location, for example, L1, or the charging location, for example, L3 in the at least one production circuit, for example, C1 within the predefined time period or over different predefined time periods. In embodiments, the coordination module 455 is configured to determine a variation between the predefined count and the actual count monitored corresponding to the predefined time period(s). In embodiments, the determined variation can be effected as a result of a variation in the determined machine cycle time, for example, the machine cycle time or the time taken by each machine, for example, 110-1 to load material to a maximum capacity of each machine at the predefined location such as the loading location, for example, L1 or to charge each machine, for example, 110-2 to the predefined target state of charge at the predefined location such as the charging location, for example, L3 in the at least one production circuit, for example, C1. In embodiments, the variation in the determined machine cycle time can be impacted based on worksite related factors including, but not limited to, worksite conditions associated with the at least one path, for example, P1 in the at least one production circuit, for example, C1, availability or supply of the loading material or a loading capacity of a loading device at the loading location, for example, L1, availability of the electrical power and/or a charging rate at the charging location, for example, L3. For example, the machine cycle time to the perform the task of loading material onto each machine, for example, 110-1 at the loading location, for example, L1 may increase or decrease based on the availability or supply of the loading material and/or the loading capacity of a loading device. Similarly, the machine cycle time to charge each machine, for example, 110-1 at the charging location, for example, L3 may increase or decrease based on the availability the electrical power and/or the charging rate of each machine, for example 110-1 at the dynamic charging trolley provided at the charging location, for example, L3.

In such embodiments, to account for the variations in the determined machine cycle time due to, for example, the worksite conditions, the coordination module 455 is configured to perform at least one action to account for the variations. For example, based on the monitored actual count and the determined variation, the coordination module 455 is configured to perform the at least one action of dynamically modifying the determined time duration of the distance to be maintained between the at least one set of machines, for example, 110-1 through 110-6 such that the actual count of the at least one set of machines, for example, 110-1 through 110-6 present at the predefined location within the predefined time period and/or over the different predefined time periods is equal to or substantially equal to the predefined count. As an example, for instances when the actual count is less than the predefined count within the predefined period or when the determined variation is less than a first predefined threshold count, the coordination module 455 is configured to dynamically reduce the determined time duration of the distance of the at least one set of machines, for example, 110-1 through 110-6 and co-ordinate the movement of the at least one set of machines based on the reduced time duration until the monitored actual count within the predefined time period or over the different time period(s) is equal to or substantially equal to the predefined count. Similarly, for instances when the actual count is greater than the predefined count within the predefined period or when the determined variation is greater than a second predefined threshold count, the coordination module 455 is configured to increase the determined time duration of the distance of the at least one set of machines, for example, 110-1 through 110-6 and co-ordinate the movement of the at least one set of machines based on the increased time duration until the monitored actual count within the predefined time period or over the different time period(s) is equal to or substantially equal to the predefined count. It will be apparent to those with ordinary skill in the art that the coordination module 455 is also configured to continuously monitor the actual count of the at least one set of machines, for example, 110-1 through 110-6 present at the predefined location within the predefined time period or over the different predefined time periods based on each dynamically modified time duration by the coordination module 455. It will be apparent to those with ordinary skill in the art that the coordination module 455 is also configured to continuously perform the at least one action until the actual count is equal to or substantially equal to the predefined count.

### Industrial Applicability

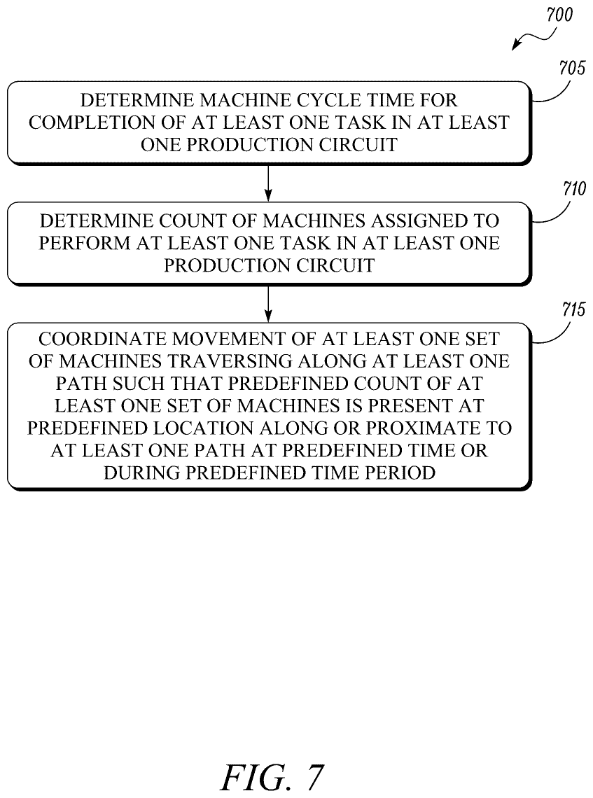

Referring to FIG. 7, a method 700 for managing a plurality of machines, for example, 110, 115, 125, 130, 135, 140, 145 employed in the worksite 100 of FIGS. 1-3, via the system 105 of FIG. 4 is disclosed. At step 705, the system 105 is configured to determine a machine cycle time for completion of at least one task in at least one production circuit, for example, C1, C2 (see FIG. 1). The at least one production circuit comprises at least one path, for example, P1 (see to be traversed by at least one set of machines, for example, 110-1 through 110-6 (see FIG. 1) of the plurality of machines, for example, 110, 115, 125, 130, 135, 140, 145 to complete the at least one task. At step 710, the system 15 is configured to determine a count of the at least one set of machines, for example, 110-1 through 110-6 assigned to perform the at least one task in the at least one production circuit, for example, C1. At step 715, the system 105 is configured to coordinate a movement between the at least one set of machines, for example, 110-1 through 110-6 such that a predefined count of the at least one set of machines, for example, 110-1 through 110-6 is present at a predefined location along or proximate to the at least one path, for example, P1 at a predefined time or during the predefined time period.

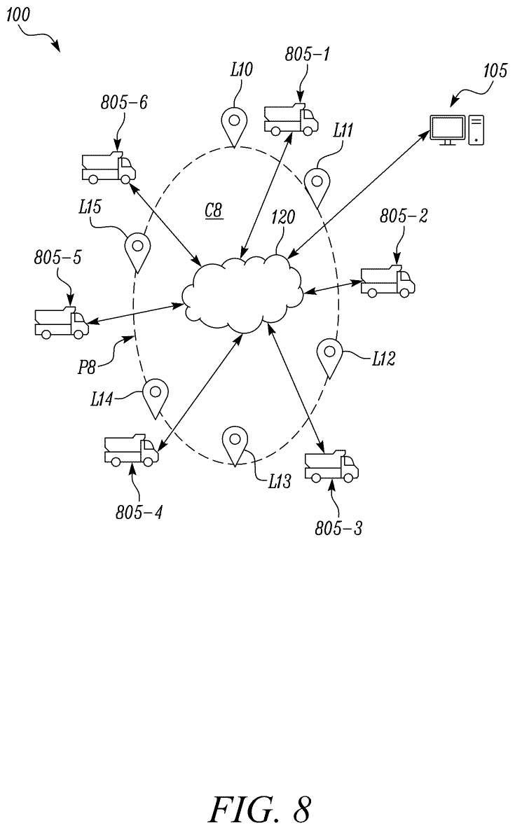

Referring to FIG. 8, an exemplary illustration of the worksite 100 of FIG. 1 including the system 105 of FIG. 4 for managing battery electric machines (BEMs), for example, 805-1 through 805-6 in a production circuit C8 provided within the worksite 100 is disclosed. The production circuit includes a path P8 and locations, for example, L10 through L15 to be traversed by the machines, for example, 805-1 through 810-6 at least one once to complete at least one task. In embodiments, the at least one task corresponds to loading a material from the location L10 and dumping the loaded material at location L15 by each BEM. In embodiments, the location, for example, L10 corresponds to a material loading location such as, for example, the run-of-mine (ROM) pad or the stockpile, the locations, for example, L11 through L14 correspond to machine charging locations for charging the BEMs, for example, 805-1 through 805-6, and the location L15 corresponds to a material dumping location. In embodiments, the machine charging locations, for example, L10 through L15, are provided with dynamic charging trolleys (not shown) to charge the BEM(s) while traversing the locations, for example, L10 through L15 respectively.

In embodiments, the system 105 is configured to determine a machine cycle time for completion of the at least one task of loading and dumping the material from the location L10 to the location L15 in production circuit C8 by each BEM of the BEMs, for example, 810-1 through 810-6. As an example, the machine cycle time corresponds to 20 minutes. The system 105 is also configured to determine a count of the BEMs, for example, 805-1 through 805-6 assigned to perform the at least one task in the production circuit C8. Further, the system 105 is configured to determine a planned count of the machines, for example, 805-1 through 805-6, targeted to be present at the material dumping location L15 at a predefined time or during a predefined time period based on production requirements. As an example, the planned count corresponds to 1 BEM of the BEMs 805-1 through 805-6. For the planned count of 1 BEM targeted to be present at the material dumping location L15 during the predefined time period, the system 105 is configured to determine a time duration of distance to be maintained between the BEMs, for example, 805-1 through 805-6 by dividing the determined machine cycle time with the determined count of the BEMs. For example, the determined time duration of distance to be maintained between the BEMs, for example, 805-1 through 805-6 is equal to 3.33 minutes for the machine cycle time of 20 minutes and the count of 6 BEMs in the production circuit C8. In embodiments, the system 105 is configured to coordinate movement of the BEMs, for example, 805-1 through 805-6 traversing along the path, for example, P8 such that the planned count of, for example, 1 BEM is present at the material dumping location L15 along the path P8 during the predefined time period by maintaining the determined time duration of distance of, for example, 3.33 minutes between the BEMs, for example, 805-1 through 805-6.

In embodiments, the system 105 is also configured to determine an estimated time period of or an estimated time duration between an availability of electrical power at each machine charging location, for example, L11 to L14 and determine the time duration of distance to be maintained between the BEMs, for example, 805-1 through 805-6 based on the determined estimated time period or time duration. For example, the system 105 is also configured to determine an estimated time duration between an availability of electrical power at each machine charging location to be, for example, 3 minutes and determine that the predefined time period of availability of electrical power at each machine charging location is after the determined estimated time duration. In such embodiments, the system 105 is configured the determine the time duration of distance to be maintained between the BEMs, for example, 805-1 through 805-6 to be equal to, for example, 3 minutes based on the determined estimated time duration of, for example, 3 minutes such that at least one BEM is present at each machine charging location, for example, L11 to L14 along the path P8 after the determined estimated time duration of, for example, 3 minutes or during the predefined time period of availability of electrical power. In embodiments, the system 105 is also configured to coordinate the movement of the BEMs, for example, 805-1 through 805-6 traversing along the path, for example, P8 based on the determined time duration of distance such that at least one BEM is present at each machine charging location, for example, L11 to L14 along the path P8 after the determined estimated time duration of, for example, 3 minutes or during the predefined time period of availability of electrical power. It will be appreciated that for instances when the machine cycle time is, for example, 20 minutes, the count of the BEMs is, for example, 6, and the estimated time duration between availability of electrical power at each machine charging location is, for example, 3 minutes, the system 105 is configured to coordinate the movement of the BEMs, for example, 805-1 through 805-6 traversing along the path, for example, P8 such that the planned count of, for example, 1 BEM is present at the material dumping location L15 during the predefined time period based on production requirements and at least one machine is also present at each machine charging location, for example, L11 through L14 during the predefined time period of the availability of electrical power at the corresponding machine charging location.

It will be apparent that the system 105 and the method 700 of the present disclosure help improve machine productivity and a production time or time of completion of one or more tasks in each production circuit as a result of the coordinated movement of the machines within each production circuit and/or the time duration of the distance maintained between the machines in each production circuit. Consequently, the system 105 and the method 700 of the present disclosure also enable optimization of the production in each production circuit since the coordinated movement of the machines may result in the planned count of the machines to be present at a desired location such as, but not limited to, the dumping location to meet the production requirements. In addition, the system 105 and the method 700 of the present disclosure may also help prevent or minimize queueing of the machines within the production circuit, for example, C1 at a given location including, but not limited to, the loading location, for example, L1, a fueling location (not shown), and/or a machine charging location, for example, L3 as a result of the time duration of distance maintained between the machines and/or the coordinated movement. Further, by maintaining the time duration of distance between the machines in each production circuit, the system 105 and the method 700 of the present disclosure enable at least one machine to be consistently present at the loading location, for example, L1 after a loading time for loading material onto another machine at the loading location, for example, L1. Furthermore, by maintaining the time duration of distance between the machines in each production circuit, the system 105 and the method 700 of the present disclosure may also ensure that available or generated electrical power at the machine charging location(s), for example, L3 having, for example, dynamic charging trolleys is optimally utilized such that at least one machine is present at the machine charging location for charging during the determined estimated time period of availability of the electrical power at the machine charging location, thereby minimizing underutilization of the available electrical power in the corresponding production circuit. Further, the system 105 and the method 700 of the present disclosure will also help meet the production requirements including, but not limited to, the production rates and/or the blend compliance requirements across different production circuits, for example, C1, C2 employed within the worksite 100 as a result of the coordinated movement and determined ratio of the count of the machines from the different production circuits being present at the predefined or same location, for example, D1 at the predefined time or during the predefined or same time period. Furthermore, the system 105 and the method 700 of the present disclosure also ensure that any variations in the machine cycle time in the production circuit(s) due to worksite events and/or conditions is accounted for by continuously monitoring the actual count of machine present at the predefined location and coordinating the movement of the machines by dynamically modifying the determined time duration of distance between the machines such that the actual count of the machines present the predefined location is equal to or substantially equal to the predefined count of the machines targeted to be present at the predefined location.

Unless explicitly stated, the use of the singular to describe a component, structure, or operation does not exclude the use of plural such components, structures, or operations or their equivalents. The use of the terms “a” and “an” and “the” and “at least one” or the term “one or more,” and similar references herein are to be construed to cover both the singular and the plural, unless otherwise indicated herein. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; or A, B and B), unless otherwise indicated herein. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A system for managing a plurality of machines, comprising:
a processor;
a memory for storing instructions that when executed by the processor, causes the processor to:
determine a machine cycle time for completion of at least one task in at least one production circuit, wherein the at least one production circuit comprises at least one path to be traversed by at least one set of machines of the plurality of machines to complete the at least one task;
determine a count of the at least one set of machines assigned to perform the at least one task in the at least one production circuit; and
coordinate movement of the at least one set of machines traversing along the at least one path based on the determined machine cycle time and the determined count such that a predefined count of the at least one set of machines is present at a predefined location along or proximate to the at least one path at a predefined time or during a predefined time period.

2. The system of claim 1, wherein the processor is configured to coordinate the movement by:
regulating a speed of travel of at least one machine of the at least one set of machines traversing along the at least one path;
directing the at least one machine to at least one location within the at least one production circuit or outside the at least one production circuit;
directing the at least one machine from a first production circuit of the at least one production circuit to a second production circuit of the at least one production circuit;
redirecting the at least one machine from the second production circuit to the first production circuit;
directing at least one first machine of the at least one set of machines travelling at a first speed to halt at a location along the at least one path and at least one second machine of the at least one set of machines travelling at a second speed to travel past the at least one first machine at the location; or
stationing the at least one machine at the location along the at least one path for a predetermined time period.

3. The system of claim 1, wherein the processor is configured to determine a time duration of a distance to be maintained between the at least one set of machines traversing along the at least one path based on the determined machine cycle time and the determined count, wherein the time duration corresponds to a time taken by each machine of the at least one set of machines to travel the distance; and wherein the determined time duration of the distance between the at least one set of machines is same or different.

4. The system of claim 3, wherein the processor is configured to:
monitor an actual count of the at least one set of machines present at the predefined location within the predefined time period;
determine a variation between the actual count and the predefined count; and
dynamically modify the determined time duration of the distance to be maintained between the at least one set of machines based on the determined variation such that the actual count is equal to or substantially equal to the predefined count.

5. The system of claim 3, wherein the processor is configured to maintain the determined time duration of the distance between the at least one set of machines traversing along the at least one path in the at least one production circuit.

6. The system of claim 1, wherein the at least one task corresponds to a first task and a second task, the at least production circuit corresponds to a first production circuit and a second production circuit, and the at least one set of machines corresponds to a first set of machines assigned to perform the first task in the first production circuit and a second set of machines assigned to perform the second task in the second production circuit.

7. The system of claim 6, wherein the processor is configured to coordinate the movement by:
directing at least one first machine of the first set of machines assigned to perform the first task in the first production circuit to perform the second task in the second production circuit; or
directing at least one second machine of the second set of machines assigned to perform the second task in the second production circuit to perform the first task in the first production circuit.

8. The system of claim 7, wherein the processor is configured to coordinate the movement by:
redirecting the at least one first machine of the first set of machines directed to perform the second task in the second production circuit to perform the first task in the first production circuit; or
redirecting the at least one second machine of the second set of machines directed to perform the first task in the first production circuit to perform the second task in the second production circuit.

9. The system of claim 6, wherein the processor is configured to:
determine a ratio of a first planned count of the first set of machines to a second planned count of the second set of machines targeted to be present at the predefined location during a same time period;
determine a first time duration of the distance to be maintained between the first set of machines and a second time duration of the distance to be maintained between the second set of machines based on the determined ratio; and
coordinate a first movement between the first set of machines traversing along a first path of the at least one path in the first production circuit and a second movement between the second set of machines traversing along a second path of the at least one path in the second production circuit based on the determined first time duration and the determine second time duration such that the first planned count of the first set of machines and the second planned count of the second set of machines are present at the predefined location during the same time period according to the determined ratio.

10. The system of claim 9, wherein the first time duration of the distance between the first set of machines operating in the first production circuit is less than, greater than, or equal to the second time duration of the distance between the second set of machines operating in the second production circuit.

11. The system of claim 6, wherein a first count of the first set of machines operating in the first production circuit is less than, greater than, or equal to a second count of the second set of machines operating in the second production circuit.

12. The system of claim 6, wherein the machine cycle time to complete the first task in the first production circuit is same as or different from the machine cycle time to complete the second task in the second production circuit.

13. The system of claim 6, wherein the at least one production circuit comprises a plurality of production circuits, and the processor is configured to:
determine at least one cluster of production circuits of the plurality of production circuits based on at least one location common to or proximate to at least one set of production circuits of the plurality of production circuits, wherein the at least one determined cluster comprises the first production circuit and the second production circuit and the at least one location comprises or corresponds to the predefined location;
determine a cumulative count of the at least one set of machines assigned to perform the at least one task in each production circuit of the at least one set of production circuits in the at least one determined cluster; and
coordinate movement of the at least one set of machines traversing along the at least one path in each production circuit of the at least one set of production circuits in the at least one determined cluster based on at least one of the determined cumulative count, the determined count in each production circuit, or the determined machine cycle time such that the predefined count of the at least one set of machines from each production circuit is present at the at least one location along or proximate to the at least one path at the predefined time or during the predefined time period, or
coordinate movement of at least one machine of the at least one set of machines between at least two production circuits of the at least one set of production circuits in the at least one determined cluster based on at least one of the determined cumulative count, the determined count in each production circuit, or the determined machine cycle time such that the predefined count of the at least one set of machines from each production circuit is present at the at least one location at the predefined time or during the predefined time period.

14. A system for managing a plurality of machines, comprising:
a processor;
a memory for storing instructions that when executed by the processor, causes the processor to:
determine a first machine cycle time for completion of a first task in a first production circuit and a second machine cycle time for completion of a second task in a second production circuit, wherein the first production circuit comprises at least one first path traversed by a first set of machines of the plurality of machines to complete the first task, and the second production circuit comprises at least one second path traversed by a second set of machines of the plurality of machines to complete the first task;
determine a first count of the first set of machines assigned to perform the first task and a second count of the second set of machines assigned to perform the second task;
determine a ratio of a first planned count of the first set of machines to a second planned count of the second set of machines targeted to be present at a predefined location during a same time period; and
coordinate a first movement between the first set of machines traversing along the at least one first path and a second movement between the second set of machines traversing along the at least one second path based on the determined first machine cycle time, the determined first count, the determined second machine cycle time, and the determined second count such that the first planned count of the first set of machines and the second planned count of the second set of machines are present at the predefined location during the same time period according to the determined ratio.

15. The system of claim 14, wherein the processor is configured to coordinate the first movement or the second movement by:
directing at least one first machine of the first set of machines assigned to perform the first task in the first production circuit to perform the second task in the second production circuit; or
directing at least one second machine of the second set of machines assigned to perform the second task in the second production circuit to perform the first task in the first production circuit.

16. The system of claim 15, wherein the processor is configured to coordinate the first movement or the second movement by:
redirecting the at least one first machine of the first set of machines directed to perform the second task in the second production circuit to perform the first task in the first production circuit; or
redirecting the at least one second machine of the second set of machines directed to perform the first task in the first production circuit to perform the second task in the second production circuit.

17. The system of claim 14, wherein processor is configured to determine a first time duration of a first distance to be maintained between the first set of machines traversing along the at least one first path based on the determined first machine cycle time, the determined first count, and the determined ratio, and a second time duration of a second distance to be maintained between the second set of machines traversing along the at least one second path based on the determined second machine cycle time, the determined second count and the determined ratio; and wherein the first time duration of the distance between the first set of machines operating in the first production circuit is less than, greater than, or equal to the second time duration of the distance between the second set of machines operating in the second production circuit, and the first count of the first set of machines operating in the first production circuit is less than, greater than, or equal to the second count of the second set of machines operating in the second production circuit.

18. The system of claim 17, wherein the processor is configured to maintain the determined first time duration between the first set of machines and the determined second time duration between the second set of machines such that the first planned count of the first set of machines and the second planned count of the second set of machines are present at the predefined location during the same time period according to the determined ratio.

19. A method for managing a plurality of machines, comprising:
determining a machine cycle time for completion of at least one task in at least one production circuit, wherein the at least one production circuit comprises at least one path to be traversed by at least one set of machines of the plurality of machines to complete the at least one task;
determining a count of the at least one set of machines assigned to perform the at least one task in the at least one production circuit; and
coordinating a movement between the at least one set of machines based on the determined machine cycle time and the determined count such that a predefined count of the at least one set of machines is present at a predefined location along or proximate to the at least one path at a predefined time or during a predefined time period.

20. The method of claim 19, comprising: determining a time duration of a distance to be maintained between the at least one set of machines traversing along the at least one first path based on the determined machine cycle time and the determined count, wherein the time duration corresponds to a time taken by each machine of the at least one set of machines to travel the distance, and wherein the coordinating of the movement comprises:
regulating a speed of travel of at least one machine of the at least one set of machines traversing along the at least one path;
directing the at least one machine to at least one location within the at least one production circuit or outside the at least one production circuit;
directing the at least one machine from a first production circuit of the at least one production circuit to a second production circuit of the at least one production circuit;
directing at least one first machine of the at least one set of machines travelling at a first speed to halt at a location along the at least one path and at least one second machine of the at least one set of machines travelling at a second speed to travel past the at least one first machine at the location;
redirecting the at least one machine from the second production circuit to the first production circuit; or
stationing the at least one machine at a location along the at least one path for a predetermined time period.
